(19) United States
(12) Patent Application Publication
(10) Pub. No.: US 2014/0314974 A1
(43) Pub. Date: Oct. 23, 2014

(54) COMPOSITE MATERIALS FOR HIGH PRESSURE MANUFACTURING

(71) Applicants: Navin Chandra Parsana, Mumbai (IN); Ashwin B. Choksi, Mumbai (IN)

(72) Inventors: Navin Chandra Parsana, Mumbai (IN); Ashwin B. Choksi, Mumbai (IN)

(73) Assignee: Guilin Color Engineered Diamond Technology (EDT) Co., LTD, Guilin (CN)

(21) Appl. No.: 13/893,485

(22) Filed: May 14, 2013

(30) Foreign Application Priority Data
Apr. 19, 2013 (CN) 201310137855.4

(51) Int. Cl. B32B 1/02

(52) U.S. Cl. CPC B32B 1/02
USPC 428/34.1

(57) ABSTRACT

A composite cube for use in high pressure high temperature technology may provide improved rigidity, stability, consistency in heating, flow, pressure transmission, and thermal insulation during manufacturing. The composite cube may comprise an inner core and an outer shell. The inner core may comprise at least one ring and at least one inner cap that surround an internal bore region of the composite cube. The inner core may be formed from a binder and a nonflowable material. The outer shell may be formed from a flowable material and binder.

### RELATED APPLICATIONS

This application claims the benefit of Chinese Patent Application No. 201310137855.4, filed on Apr. 19, 2013 which is incorporated herein by reference.

### FIELD OF THE INVENTION

This invention relates to composite materials, such as a composite container. More particularly, to composite materials utilized for high pressure and/or high temperature manufacturing.

### BACKGROUND OF INVENTION

High pressure and/or high temperature technology for production of diamond crystals and polycrystalline diamond compacts involves application of extreme pressure and temperatures. For example, in high pressure and/or high temperature technology, pressure may exceed 70 Kilobars and temperatures may be in excess of 1500° C. A high pressure press is capable of applying sufficient pressure for maintaining thermodynamically stable conditions at synthesis temperatures for diamond. The high pressure press may provide six anvils that are positioned at 90 degree angles with respect to adjacent anvils and converge on a container, such as a cube, when the press is operated. The cube material extrudes under this condition and eventually forms a seal between adjacent anvils edge portions. The cube may be heated by electrical means to achieve desired temperature for manufacture of polycrystalline products.

The container utilized to manufacture polycrystalline products may be a sealing gasket produced from natural pyrophyllite stones, a natural form of hydrous aluminum silicate found in metamorphic rocks. Pyrophyllite may deform or flow under pressure to provide a pressure seal and may transmit pressure from anvil to material contained by the sealing gasket. Pyrophyllite also displays good thermal insulating characteristics that help to reduce the amount of heat that is transferred from the cube to the anvils during sintering.

Naturally occurring pyrophyllite, either in the form of agglomerates or powder, introduces variation and inconsistency into the high pressure process because of wide variation in chemical composition and cementation process that occurs in the metamorphic rock formation processes. Moisture content and chemical composition variation occurs in natural pyrophyllite over a wide range, which impacts operation of high pressure equipment and the products made using this material.

Moreover, during application of pressure, the interior of the gasket deforms at a rate different than the outer body of the gasket. The bore of the gasket supports heating devices (e.g. graphite or grafoil heating assemblies) that are heated by passing electrical current through it. As the interior bore of the cube deforms, so does the heating element causing variation in the electrical resistance from the top of the cube to the interior. This deformation is not always constant and hence heating varies from one operation to the other.

A composite sealing container comprising materials that do not display variations in composition or inconsistencies may be utilized in high pressure manufacturing. An interior of the composite sealing container may provide minimum deformation and consistent heating. The container may be formed from conventional and readily available materials and be produced using traditional production techniques.

### SUMMARY OF THE INVENTION

In one embodiment, a composite cube may comprise an inner core and an outer shell. The inner core may comprise at least one ring and at least one inner cap that fully or partially surround an internal bore region of the composite cube. The inner core may be formed from a binder and a nonflowable material. The outer shell may comprise at least one outer cube and at least one outer cap that surround the inner core. The outer shell may be formed from a flowable material and binder.

In some embodiments, the inner core may comprise an inner core material and a binder. In some embodiments, the inner core may comprise dolomite, garnet, materials comprising aluminum silicate or calcium silicate, or a combination thereof. In some embodiments, the inner core material comprises 80% or greater by volume of the inner core. In some embodiments, the inner core material has an average particle size equal to or greater than 120 U.S. mesh and equal to or less than 325 U.S. mesh.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 is an illustrative embodiment of cubic press anvils and a composite sealing container; and

FIG. 2 is an illustrative embodiment of a composite cube configuration with an internal core and outer shell.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

A composite material for high pressure manufacturing may comprise a container providing an outer shell and an inner core. In some embodiments, the outer shell and inner core may be made from different materials. The inner core may completely or partially surround an internal bore of the container. The internal bore defines a region where materials utilized to produce diamond crystals and polycrystalline diamond compacts are placed. The inner core is preferably made from nonflowable hard material(s), such as dolomite, a hard mineral powder, or a combination thereof. The outer shell comprises a flowable material that surrounds the inner core to form the composite container that may be utilized in high pressure manufacturing. In some embodiments, the outer shell comprises mainly clay mineral powder, such as talc, having sufficient lubricity to flow during application of high pressure. The outer shell may also comprise a lesser proportion of at least one hard material(s), such as zircon or other hard mineral powers, having sufficiently greater hardness than the clay mineral powder to retard flow of the clay mineral and form a seal during pressing. In a preferred embodiment, a composite container for high pressure manufacturing may be in the shape of a cube. However, in other embodiments, the composite container may be a polyhedron, hexahedron, cylinder, or the like.

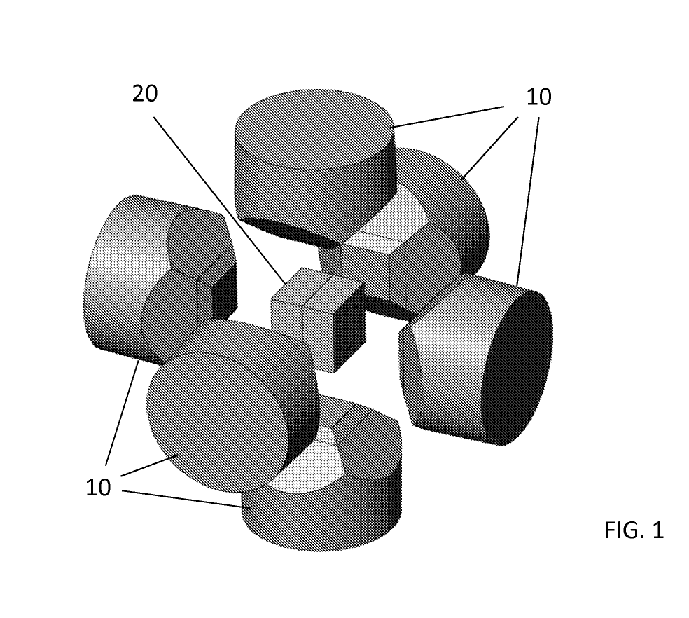

FIG. 1 is an illustrative embodiment of cubic press anvils 10 and a composite sealing container 20. A cubic press may provide six anvils 10 in three oppositely oriented matching precisely aligned pairs. Each anvil 10 has square face and a sloping shoulder portion. The anvils 10 at least two of which are electrically insulated from the body of the press and from each other are attached to the piston that is housed in cylinders. The anvils 10 are aligned for linear movement along three mutually perpendicular coordinate axis. The movement of anvils 10 may be synchronized by a common hydraulic system that allows oil to flow at equal pressure to all six cylinders through use of solenoid valves. All six cylinders may be fastened together by an arrangement of hinges and pins. The thrust of six anvils 10 simultaneously moves the anvils towards the symmetry center of the press about a composite cubic shaped cell 20.

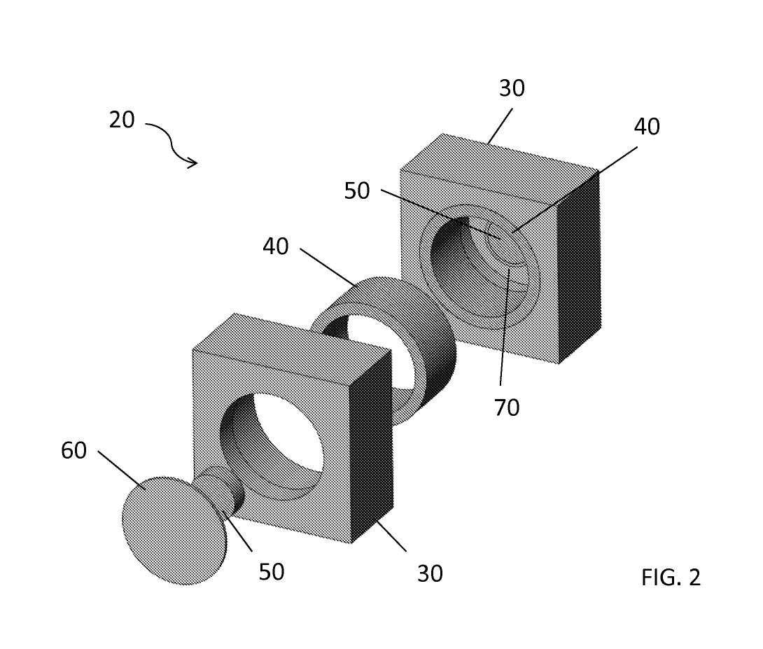

FIG. 2 is an illustrative embodiment of a composite cube 20 configuration with an internal core and outer shell. The composite cube 20 is configured having six square faces that are greater in area than the adjacent anvils faces. Advance of the anvils against cube faces extrudes and compresses material from the composite cube between the sloping shoulder portions of anvils, thereby forming a seal. The pressure from anvils is transmitted to a load (not shown) housed in the internal bore of the composite cube. The load can be designed for production of diamond crystals or polycrystalline compacts. For example, in the embodiment shown the internal bore is a cylindrically shaped area surrounded by the composite cube 20 where the load would be placed to form a cylindrically shaped diamond crystals or polycrystalline compact. After a predetermined pressure has been transmitted by anvils to the composite cube, an electrical current is directed to the load via heating element within a passage. The heat generated by heating element is transmitted by thermal conduction or radiation to the load disposed within the composite cube. After a predetermined amount of time the temperature of the load and pressure transmitted to the load are reduced.

The composite cube 20 comprises an inner core and an outer shell. The inner core is harder than the outer shell to prevent or minimize deformation during operation of the press. The composite cube 20 surrounds an internal bore region that holds a load utilized to form diamond crystals or polycrystalline compacts. The internal bore region is illustrated as a cylindrical region surrounded by outer cubes 30, inner rings 40, inner caps 50, and outer caps 60. However, in other embodiments, internal bore region may be any shape that may be desirable for diamond crystals or polycrystalline compacts. The load is not shown for the purposes of clarity. Inner core may fully or partially surround the internal bore region to define the shape of a compact to be formed. A portion of the internal bore may provide heating elements 70. Inner core is formed from a hard nonflowable material to prevent or minimize deformation during high pressure manufacturing. Nonflowable materials as discussed herein refer to materials that prevent or minimize deformation when subjected to extreme pressure (e.g. 70 kilobars or greater) or extreme temperatures (1500° C. or greater). Further, the nonflowable material may have beneficial heat insulating properties, may be rigid to maintain its shape, and stable at high temperature conditions encountered during high pressure high temperature manufacturing. By utilizing an inner core formed from nonflowable material, the composite cube 20 retains heat and minimizes deformation at high pressures and temperatures that could result in deformation that changes resistivity, which may cause inconsistent heating of the cube.

In some embodiments, inner core may comprise inner rings 40 and cap 50. Inner rings 40 and cap 50 may be formed from a hard nonflowable material, such dolomite, garnet, materials comprising aluminum silicate or calcium silicate, other hard mineral powder(s), or a combination thereof. For example, the inner rings 40 and cap 50 may be fabricated by pressing powder of dolomite mineral mixed with a binder. In some embodiments, the inner core may be about 2-5 mm thick. In some embodiments, the hard nonflowable material for the inner core may have an average particle size in the range of about 120-325 U.S. mesh. In some embodiments, the hard nonflowable material for the inner core may have an average particle size in the range of about 200-325 U.S. mesh. In some embodiments, the hard nonflowable material may comprise about 80% or greater by volume the inner core. In an illustrative embodiment, the inner core may be dolomite, which has good heat insulating properties and has the ability to resist or minimize deformation resulting from consistent heating during high pressure high temperature operations.

Binders for inner core may be solids or liquids that allow the hard material powder to bind together to form a homogeneous integral body. Nonlimiting examples of binders may include sodium silicate, acrylic polymers, Portland cement or like. The binders may be inorganic or organic, but should be selected materials that do not produce gas during the high pressure high temperature process. In some embodiments, inorganic binders are preferred because they do not produce gas at high temperatures.

Outer shell surrounds the inner core and may comprise outer cubes 30 and outer caps 60. The outer cubes 30 and outer caps 60 may be formed by thoroughly mixing together in desired proportions the clay mineral, hard material powder and a binder. The outer cubes 30, inner rings 40, inner caps 50, and outer caps 60 are then co-formed to produce the composite cube 20. Outer cube 30 should be made from flowable materials that will allow it to deform or flow during high pressure manufacturing so that a seal forms when the material is extruded and compressed by anvils 10. Flowable materials as discussed herein refer to materials that deform or flow when subjected to extreme pressure (e.g. 70 kilobars or greater) or extreme temperatures (1500° C. or greater). The composite cube 20 may be heated for a sufficient time and at sufficient temperature to remove non-crystallographic water. The resulting composite cube 20 may then be filled with a load and placed in a high pressure press to form diamond crystals or polycrystalline compacts.

A suitable clay mineral powder for the outer shell may be selected from readily available family of clays, such as akermanite (Ca₂Mg₂Si₂O₂), betrandite (Be₂Al₂Si₆O₁₆), kaolinite (Al₄Si₆)₁₀(OH)₈, pyrophyllite (Al₄Si₄O₁₀)(OH)₂, high alumina talc, low alumina talc, any other suitable clay, or a combination thereof. In some embodiments, the clay mineral powder may have an average particle size in the range of about 10 to 200 microns. In other embodiments, any suitable average particle size may be utilized. In some embodiments, the clay material may comprise about 60% or greater by weight of the outer shell.

Additionally, the outer shell includes a hard material(s), having a sufficiently greater hardness than the clay mineral, to restrict or retard flow the clay mineral during pressing. In some embodiments, the hard materials for the outer shell have a hardness that is 2 or more times harder than the clay mineral. In some embodiments, the hard materials for the outer shell have a hardness that is 2-4 harder than the clay mineral. The particles of hard materials may increase the internal friction of the outer shell as it flows under high pressure. Suitable hard material powders include, but are not limited to, calcite, wollastonite (CaSiO₃), silica (SiO₂), alumina (Al₂O₃), iron oxide, zircon (ZrSiO₄), garnets (e.g. CaₓAl_{y}Si₃O₁₂) and the like. It is desired that hard material powder has an average particle size of about 120 to 325 U.S. mesh size. In some embodiments, the hard material powder has an average particle size of about 200 to 325 U.S. mesh size. In other embodiments, any suitable average particle size may be utilized. In a preferred embodiment, the hard material powder for the outer shell is calcite or wollastonite. In some embodiments, the outer shell or gasket material may contain about 5 to 30 by weight percent hard material powder.

Binders for outer shell may be solids or liquids that allow the clay mineral and hard material powder to bind together to form a homogeneous integral body with the inner core. Nonlimiting examples of binders may include sodium silicate, acrylic polymers, Portland cement or like. The binders may be inorganic or organic, but should be selected materials that do not produce gas during the high pressure high temperature process. In some embodiments, inorganic binders are preferred because they do not produce gas at high temperatures. An outer shell material may comprise in the range of about 5 to 30 percent by weight binder. For example, the outer shell material may contain about 5 to 12 percent by weight of aqueous sodium silicate solution. Sodium silicate may be preferred because of its better adhesive properties forms a more homogeneous mixture of clay mineral and the hard material powder.

The composite cube prepared displays consistent and improved flow, consistent and improved pressure transmission, improved thermal insulating characteristics, and improved stability at high temperatures when compared with cubes made from natural pyrophyllite due to the improved compositional consistency and low moisture content. Additionally, because the inner core prevents or minimizes deformation during application of high pressure and/or high temperature, the composite container provides more consistent heating during high pressure high temperature operations.

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A composite container for high pressure manufacturing in a high pressure press, the composite container comprising:
an inner core defining a shape of an internal bore region, wherein the inner core comprises a nonflowable material that prevents or minimizes deformation at extreme pressures or extreme temperatures; and
an outer shell surrounding the inner core, wherein the outer shell is less rigid than the inner core, and the outer shell is a flowable material.

2. The composite container of claim 1, wherein the inner core comprises at least one ring and at least one inner cap.

3. The composite container of claim 1, wherein the outer shell comprises at least one outer cube and at least one outer cap.

4. The composite container of claim 1, wherein the nonflowable material of the inner core comprises an inner core material selected from dolomite, garnet, materials comprising aluminum silicate or calcium silicate, or a combination thereof.

5. The composite container of claim 4, wherein the inner core material comprises 80% or greater by volume of the inner core.

6. The composite container of claim 4, wherein the inner core material has an average particle size equal to or greater than 120 U.S. mesh and equal to or less than 325 U.S. mesh.

7. The composite container of claim 1, wherein the inner core fully or partially surrounds an internal bore region.

8. The composite container of claim 1, wherein the flowable material of the outer shell comprises a clay mineral, outer core material, and binder.

9. The composite container of claim 8, wherein the clay mineral comprises 60% or greater by weight of the outer shell.

10. The composite container of claim 8, wherein the outer core material comprises 5-30% by weight of the outer shell.

11. The composite container of claim 8, wherein the clay mineral and outer core material have an average particle size equal to or greater than 120 U.S. mesh and equal to or less than 325 U.S. mesh.

12. The composite container of claim 8, wherein the outer core material is 2 or more times harder than the clay mineral.
